(19) United States
(12) Patent Application Publication
(10) Pub. No.: US 2025/0174912 A1
(43) Pub. Date: May 29, 2025

(54) ANTENNA ASSEMBLY FOR A VEHICLE AND ROOF ASSEMBLY FOR A VEHICLE

(71) Applicant: Volvo Car Corporation, Göteborg (SE)

(72) Inventors: Hanieh Aliakbariabar, Göteborg (SE); Christian Lötbäck, Göteborg (SE); Buon Kiong Lau, Göteborg (SE); Xiaotian Li, Göteborg (SE)

(73) Assignee: Volvo Car Corporation, Göteborg (SE)

(21) Appl. No.: 18/961,746

(22) Filed: Nov. 27, 2024

(30) Foreign Application Priority Data
Nov. 29, 2023 (EP) 23212992.4

(51) Int. Cl. H01Q 21/06; H01Q 1/32; H01Q 13/10; H01Q 21/22

(52) U.S. Cl. CPC H01Q 21/064; H01Q 13/10; H01Q 21/22; H01Q 1/32

(57) ABSTRACT

In an aspect, the disclosure relates to an antenna assembly comprising at least three tapered slot antennas; wherein each of the tapered slot antennas comprises a plate-shaped conductor and a tapered slot extending in the plate-shaped conductor and extending along a slot direction; wherein the slot direction of each of the tapered slot antennas is substantially oriented towards a center point of the antenna assembly; wherein the tapered slot of each of the tapered slot antennas tapers towards the center point; and wherein the slot direction of each of the tapered slot antennas are distributed with respect to a circumference extending around the center point.

### CROSS-REFERENCE TO RELATED APPLICATIONS

This application claims the benefit of European Patent Application Number 23212992.4, filed on Nov. 29, 2023, which is hereby incorporated by reference in its entirety.

### TECHNICAL FIELD

The present disclosure relates to an antenna assembly for a vehicle.

Moreover, the present disclosure is directed to a roof assembly for a vehicle comprising an antenna assembly.

### BACKGROUND

Modern vehicles may be connected to wireless services such as AM/FM radio, Digital Audio Broadcasting (DAB), Global Navigation Satellite System (GNSS), Remote Keyless Entry (RKE), tire pressure monitoring system (TPMS), Electronic Toll Collection (ETC), cellular connectivity (Long Term Evolution (LTE), 4G, 5G), Bluetooth, Wi-Fi and V2X communication. Thereby, functionalities such as infotainment, access control, communication, positioning, and safety may be provided to a user of the vehicle.

For each of these services, one or more antennas are needed to transmit and/or receive the corresponding signals from or at the vehicle. Thus, a certain number of antennas may need to be fitted in a modern vehicle. In this context, it is known to provide at least some antennas in a module often called a “shark-fin”, i.e. a module comprising antennas which is arranged on a roof of the vehicle. However, the packaging of multiple antennas in a vehicle still presents a challenge.

### SUMMARY

It is an objective of the present disclosure to solve or at least alleviate this challenge.

The problem is at least partially solved or alleviated by the subject matter of the independent claims of the present disclosure, wherein further examples are incorporated in the dependent claims.

According to a first aspect, there is provided an antenna assembly for a vehicle. The antenna assembly comprises at least three tapered slot antennas. Each of the tapered slot antennas comprises a plate-shaped conductor and a tapered slot extending in the plate-shaped conductor. Each of the tapered slots extends along a slot direction. All slot directions are substantially oriented towards a center point of the antenna assembly and all tapered slots taper towards the center point. The slot directions are distributed with respect to a circumference extending around the center point. In other words, the tapered slot antennas are arranged in a star-shape, wherein the wide ends of the slots represent the tips of the star-shape. In this context, the fact that the slot directions are substantially oriented towards a center point of the antenna assembly means that the slot directions are either oriented towards the center point of the antenna assembly or towards a location close to the center point, e.g. at a maximum distance of 0.03 times a largest wavelength of the bandwidth of the antenna assembly or at a maximum distance of 15 mm. While a single one of the tapered slot antennas has a so-called endfire radiation pattern, i.e. a unidirectional pattern where the major lobe occurs at one end, the antenna assembly, i.e. the combination of at least three of such tapered slot antennas, realizes a multidirectional or omnidirectional pattern. This is useful for an application in a vehicle since a position and orientation of the vehicle with respect to a sender or receiver remote from the vehicle usually varies during the use of the vehicle. At the same time, tapered slot antennas have wideband characteristics. This means that a tapered slot antenna may be operated with approximately or exactly the same operating characteristics over a very wide range of frequencies or wavelengths. These frequencies or wavelengths may be defined by an associated bandpass filter. Thus, the antenna assembly comprising at least three tapered slot antennas provides both a multi-directional or omni-directional radiation pattern and wideband characteristics. Additionally, single tapered slot antennas and assemblies of tapered slot antennas provide good impedance matching capabilities. This facilitates the integration of an antenna assembly into a vehicle from an electric perspective. This is especially the case if the antenna is to be integrated into a roof assembly of the vehicle, wherein the roof assembly may comprise glass material. It is usually difficult to perform the impedance matching in relatively high permittivity environments such as glass. Stated otherwise, known antennas typically designed for operation in low-permittivity environments cannot provide good radiation performance in a high permittivity environment. This may result in comparatively low radiation efficiency and/or comparatively low gain. In contrast thereto, the antenna assembly according to the present disclosure may be well adapted to such environments such that a high radiation performance can be achieved. This may result in comparatively high radiation efficiency and/or the realization of an intended radiation pattern, e.g. high gain. At the same time, such an antenna assembly is compact in size. First of all, this applies to a direction perpendicular to a plane of the plate-shaped conductors. In other words, such an antenna assembly has a comparatively small height or is comparatively flat. This remains the case even if the antenna assembly is slightly curved or bent due to an integration in a slightly curved or bent portion of a vehicle, e.g. a roof assembly of the vehicle. Moreover, the dimensions of the antenna assembly lying within a plane defined by the plate-shaped conductors are smaller than a wavelength at which the antenna assembly is operated. Among other things this may be positively influenced by a high-permittivity environment, e.g. glass material. More precisely, the dimensions of the antenna assembly lying within a plane defined by the plate-shaped conductors is small as compared to a central wavelength and/or as compared to a largest wavelength at which the antenna assembly is operated. This offers the possibility to integrate such an antenna assembly into a vehicle in a manner that improves aerodynamics and/or aesthetics compared to known ways of integrating antenna assemblies, e.g. shark fins. Furthermore, such an antenna assembly is simple from a structural point of view. This also has the effect that the antenna assembly may be produced in a comparatively simple and efficient manner.

In an example, the slot directions are evenly distributed with respect to the circumference extending around the center point. In this context, evenly distributed means that an angular distance between each pair of neighboring slot directions is constant over the antenna assembly. In this case, the radiation pattern of the antenna assembly is particularly uniform.

According to an example, the antenna assembly is configured as a cellular antenna assembly. This means that the antenna assembly covers frequencies of 617 MHz to 5 GHz which corresponds to all sub-6G cellular bands. Thus, a 155% fractional broad bandwidth is needed. In this context, the bandwidth defines the range of frequencies or wavelengths at which the antenna assembly may be operated with approximately or exactly the same operating characteristics. In this context, the operating characteristics may be described by one or more performance metrics. The operating characteristics are approximately or exactly the same if the one or more performance metrics are below or above a predefined threshold. Examples of performance metrics include radiation efficiency, directivity, e.g. 3 dB from a maximum, and reflection coefficient. The bandwidth may correspond to a passband of a bandpass filter forming part of the antenna assembly or being connectable to the antenna assembly.

It is noted that sometimes tapered slot antennas are also called Vivaldi antennas. In the following, both terms will be used as synonyms.

According to an example, all tapered slots are delimited by convex, curved edges of the respective plate-shaped conductor. In this context, the edges are convex towards the associated slot, i.e. the edges bulge towards the inside of the associated slot. In an example, the edges may be defined by an exponential function, e.g. e\hat{ }ax wherein a is a constant ranging from 0.08 to 0.15. Such tapered slot antennas have an advantageous radiation pattern and bandwidth.

According to an example, each of the tapered slots has a widest slot width. The widest slot widths of neighboring tapered slot antennas are directly adjacent to one another. This means that adjacent ends of widths of neighboring slots abut against each other at the respective location of the widest slot width. According to an example, all tapered slot antennas, i.e. all conductors forming the tapered slot antennas, are located in the same plane. Such a configuration has the effect that the tapered slot antennas are arranged in a geometrically efficient manner, i.e. a comparatively high number of tapered slot antennas may be arranged on a comparatively small area. In other words, the antenna assembly is very compact. Having a comparatively high number of tapered slot antennas in a comparatively small area also is advantageous from an electric point of view since a high number of tapered slot antennas leads to an enhanced radiation pattern having less nulls in higher bands.

In an example, each of the tapered slots has a widest slot width. The widest slot width corresponds to 0.05 times to 0.15 times the largest wavelength of a bandwidth of the antenna assembly. According to an example, the widest slot width corresponds to 0.06 times to 0.13 times the largest wavelength of the bandwidth of the antenna assembly. Consequently, the tapered slots are small as compared to the largest wavelength. In this context it has been mentioned that usually, the widest slot width of a tapered slot antenna corresponds to approximately half to the largest wavelength of the bandwidth of the antenna. In an example in which the antenna assembly is configured as a cellular antenna assembly, the widest slot width may be 21 mm to 64 mm. In an example, the widest slot width may be 35 mm to 55 mm, in particular 40 mm to 50 mm. In a further specific example, the widest slot width is 44 mm. Altogether, the tapered slots and, thus, also the antenna assembly is very compact.

According to an example, each of the tapered slots has a slot length. The slot length corresponds to 0.1 times to 0.2 times the largest wavelength of a bandwidth of the antenna assembly. According to an example, the slot length corresponds to 0.11 times to 0.18 times the largest wavelength of the bandwidth of the antenna assembly. In this context, the slot length may be measured as a distance between two opposite ends of the tapered slot. One of the two opposite ends may be designated as a narrow end of the tapered slot and the respective other one of the two opposite ends may be designated as a wide end of the tapered slot. Consequently, the tapered slots are small as compared to the largest wavelength. In this context it has to be mentioned that usually, the slot length of a tapered slot antenna corresponds to 2 to 4 times the largest wavelength of the bandwidth of the antenna. In an example in which the antenna assembly is configured as a cellular antenna assembly, the slot length may be 43 mm to 86 mm. In an example, the slot length may be 50 mm to 70 mm, in particular 55 mm to 65 mm. In a further specific example, the slot length is 62 mm. Altogether, the tapered slots and, thus, also the antenna assembly is very compact.

It is noted that in a case in which for each of the tapered slot antennas, the slot length is small as compared to the largest wavelength of the bandwidth and the widest slot width is small as compared to the largest wavelength of the bandwidth, the tapered slot antennas as such may be considered as small as compared to the largest wavelength of the bandwidth.

In an example, the plate-shaped conductors of the at least three tapered slot antennas are galvanically and/or electromagnetically coupled. This has the effect that the tapered slot antennas forming part of the antenna assembly are coupled in the sense that they mutually influence each other also from an electric perspective. This may be referred to as strong or tight mutual coupling, especially if the tapered slot antennas are geometrically located very close to one another. According to an example, a maximum distance between slot directions of adjacent tapered slot antennas amounts to less than half the largest wavelength of the bandwidth. This maximum distance is measured at an outer circumference of the antenna assembly or at respective wide ends of tapered slots of adjacent tapered slot antennas. Preferably the maximum distance between slot directions of adjacent tapered slot antennas amounts to less 0.3 times the largest wavelength of the bandwidth, further preferably the maximum distance between slot directions of adjacent tapered slot antennas amounts to less 0.1 times the largest wavelength of the bandwidth. According to another example, the tapered slot antennas forming the antenna assembly are smaller than the largest wavelength of the bandwidth. This results in an antenna assembly being able to operate over an extremely wide frequency range, i.e. this enhances wideband characteristics. In such a configuration, the antenna assembly can support a radiation current with a wavelength much larger than the size of the element. In the present disclosure, this is a desired effect which leads to a particularly uniform, multidirectional or omnidirectional radiation pattern and/or to particularly uniform multiband characteristics. Moreover, the coupling of three or more tapered slot antennas can also be exploited to further reduce the lateral size of the antenna assembly.

According to an example, the plate-shaped conductors of the at least three tapered slot antennas are formed by a common conductor. This means that the conductors of each of the tapered slot antennas are connected in an electrically conductive manner. The above-provided explanations apply mutatis mutandis. Moreover, the fact that the conductors are formed by a common conductor also means that just one single conductor is needed for the antenna assembly. This is simple and efficient both from a structural perspective and from a production point of view. Moreover, forming the conductors as a common conductor allows for a compact design of the antenna assembly. Furthermore, this configuration leads to a reduction of costs for the antenna assembly.

According to an example, the common conductor is substantially circular, wherein the common conductor may be virtually split into a number of circular sectors corresponding to the number of tapered slot antennas. Thus, each tapered slot antenna is formed by one of the circular sectors, wherein the tapered slot is arranged centrally within the associated circular sector. Such an antenna assembly is simple and compact from a structural point of view. Moreover, such an antenna assembly may be produced in an efficient manner.

In an example, a largest radius of the common conductor corresponds to 0.15 times to 0.35 times the largest wavelength of a bandwidth of the antenna assembly. According to an example, the largest radius corresponds to 0.2 times to 0.3 times the largest wavelength of the bandwidth of the antenna assembly. In this context, the largest radius may be determined by measuring a largest diameter of the common conductor and dividing the largest diameter by two. Consequently, the common conductor is smaller than the largest wavelength. This facilitates an overall compact design. In an example in which the antenna assembly is configured as a cellular antenna assembly, the largest radius may be 100 mm to 130 mm, in particular 110 mm to 120 mm. In a specific example, the largest radius is 113.5 mm. Altogether, the antenna assembly is very compact.

In an example, at least one strip-shaped conductor element is arranged at least partially in at least one of the tapered slots. The strip-shaped conductor element may be an elongated conductor element. Additionally or alternatively, the strip-shaped conductor element may be perpendicular to the slot direction. In an example, the at least one strip-shaped conductor element is arranged adjacent to a wide end of the associated slot. According to another example, at least one strip-shaped conductor element is at least partially arranged in each of the tapered slots. Such strip-shaped conductor elements improve a radiation pattern in that a uniformity of the radiation pattern is increased. More precisely, using such strip-shaped conductor elements acts against distortions of the radiation pattern and mitigates gain variations. This is especially the case if the antenna assembly is used in a high-permittivity environment.

According to an example, the at least one strip-shaped conductor element is arranged in the same plane as the plate-shaped conductor of the associated tapered-slot antenna. According to another example, the at least one strip-shaped conductor element is arranged in a different plane as the plate-shaped conductor of the associated tapered-slot antenna. This means that the at least one strip-shaped conductor element is offset with respect to the plate-shaped conductor along a direction oriented perpendicular to a plane as defined by the plate-shaped conductor.

In an example, a group comprising a plurality of strip-shaped conductor elements is arranged at least partially in at least one of the tapered slots adjacent to a wide end of the associated slot. According to an example, such a group comprising a plurality of strip-shaped conductor elements is arranged in each of the tapered slots. Providing such a group of strip-shaped conductor elements has the same effects as providing a single strip-shaped conductor element as has been explained above. However, providing a group of strip-shaped conductor elements increases the magnitude of the effects.

According to an example, the form and size of the strip-shaped conductor elements of one group are identical. Moreover, the plurality of strip-shaped conductor elements of one group may be evenly spaced. This means that all neighboring strip-shaped conductor elements have the same distance. According to a variant in which a group comprising a plurality of strip-shaped conductor elements is arranged in each of the tapered slots, all strip-shaped conductor elements of the antenna assembly may have the same form and size. Moreover, the spacing in each of the groups may be even and the distance at which the strip-shaped conductor elements are spaced may be the same for the entire antenna assembly. Such a configuration is structurally simple and therefore may be produced in an efficient manner.

According to other examples, the shape and size of the strip-shaped conductor elements may vary. Additionally or alternatively, a spacing between adjacent strip-shaped conductor elements may vary. This leads to improvements in the radiation pattern when considering an elevational plane.

According to still another example, at least one strip-shaped conductor element may be located in one layer and at least one strip-shaped conductor element may be located in another layer, wherein the layers are offset from one another.

According to an example, the antenna assembly comprises four to one hundred tapered slot antennas. Examples of the antenna assembly may comprise 6, 8, 12, 16, 24, 32, 36, 40, 48, 64, 72, or 96 tapered slot antennas. It has been found that antenna assembly comprising four to one hundred slot antennas show a particular performant combination of both a multi-directional or omni-directional radiation pattern and wideband characteristics. Additionally, such antenna assemblies provide good impedance matching capabilities and are highly compact. This facilitates the integration of such an antenna assembly into a vehicle from both an electric perspective and a mechanical perspective.

In an example, at least a portion of the conductor comprise an at least partially transparent or translucent material or a mesh material. In this context, the transparency or translucency applies to the visible spectrum. In case a mesh material is used, a human being can look through the voids of the mesh. This allows to integrate the antenna assembly in the locations of a vehicle for which transparency or translucency is important or even required, e.g. in glass parts. Thus, the integration of such an antenna assembly is subject to less restrictions as compared to non-transparent or non-translucent conductors. Consequently, the antenna assembly of the present disclosure may be integrated in a mechanically, electrically and aesthetically suitable place. Put otherwise, the flexibility of integration is increased.

Examples of at least partially transparent or translucent materials include graphene, Indium Tin Oxides (ITO), Aluminum Zinc Oxide (AZO), Fluorine-doped Tin Oxide (FTO), Gallium-doped Zinc Oxide (GZO), ITO/copper/ITO nanocomposite films, Indium Gallium Zinc Oxide (InGaZnO4), Zinc Oxide (ZnO), Silver-coated Polyester (AgHT-8 or AgHT-4), Silver nanowire (AgNW) or Copper nanowire (CuNW).

The mesh material can be a metal mesh material, e.g. a copper mesh material.

According to an aspect, an antenna assembly comprises: at least three tapered slot antennas; wherein each of the tapered slot antennas comprises a plate-shaped conductor and a tapered slot extending in the plate-shaped conductor and extending along a slot direction; wherein the slot direction of each of the tapered slot antennas is substantially oriented towards a center point of the antenna assembly; wherein the tapered slot of each of the tapered slot antennas tapers towards the center point; and wherein the slot direction of each of the tapered slot antennas are distributed with respect to a circumference extending around the center point.

According to a second aspect, there is provided a roof assembly for a vehicle. The roof assembly comprises a carrier layer and at least one antenna assembly according to the present disclosure. The at least one antenna assembly is arranged on the carrier layer. The carrier layer may as well be called a substrate layer. As far as the antenna assembly is concerned, the above-mentioned effects, advantages, and variants apply mutatis mutandis. This means that the antenna assembly realizes a multi-directional or omni-directional pattern. This is useful for a roof assembly of a vehicle since a position and orientation of the vehicle with respect to a sender or receiver remote from the vehicle usually varies during use of the vehicle. At the same time, the antenna assembly has wideband characteristics. Consequently, when forming part of a roof assembly, the antenna assembly may be used in connection with a plurality of wireless services associated with the vehicle. Additionally, the good impedance matching capabilities of the antenna assembly have the effect that the antenna assembly provides high performance even though it forms part of the roof assembly of the vehicle. This facilitates the integration of the antenna assembly into the roof assembly from an electric perspective, especially if the roof assembly comprises high permittivity materials such as glass. Thus, new integration possibilities for antenna assemblies are created in the context of the trend of using more glass material in roof assemblies. At the same time, the antenna assembly is compact in size as has been explained in detail further above. This offers the possibility to integrate the antenna assembly into the roof assembly in a manner that improves aerodynamics and/or aesthetics of the vehicle. Altogether, the roof assembly forms a reliable means for connecting an associated vehicle to one or more wireless services, without negatively impacting the roof assembly from an aerodynamics perspective or an aesthetic perspective.

According to an example, the antenna assembly is electrically connected to a pair of parallel feeding lines. The pair of parallel feeding lines extends between the antenna assembly and an edge of the carrier layer. This means that the pair of feeding lines also is supported on the carrier layer. In the vicinity of the edge of the carrier layer, the pair of feeding lines may be connected to an electric power source or receiver. Consequently, the antenna assembly may be operated in a simple and reliable manner.

According to an example, the roof assembly comprises a plurality of antenna assemblies according to the present disclosure, i.e. two or more such antenna assemblies. This facilitates the connection of the roof assembly and an associated vehicle to a plurality of wireless services. Additionally or alternatively such a configuration may improve the performance when using the plurality of antenna assemblies for a single wireless service.

According to an aspect, the roof assembly comprises a carrier layer and at least one antenna assembly; wherein the antenna assembly comprises of at least three tapered slot antennas; wherein each of the tapered slot antennas comprises a plate-shaped conductor and a tapered slot extending in the plate-shaped conductor and extending along a slot direction; wherein the slot direction of each of the tapered slot antennas is substantially oriented towards a center point of the antenna assembly; wherein the tapered slot of each of the tapered slot antennas tapers towards the center point; and wherein the slot direction of each of the tapered slot antennas are distributed with respect to a circumference extending around the center point; and wherein at least one antenna assembly is arranged on the carrier layer.

According to an example, the carrier layer comprises a polymer. According to another example, the carrier layer comprises a Polyvinylacetale. In this context, the carrier layer may comprise polyvinyl butyral (PVB) or may be made of polyvinyl butyral (PVB). This material is highly suitable for forming a carrier layer for an antenna assembly in a roof assembly since it is optically transparent and cost-efficient.

According to an example, the carrier layer has a permittivity of 2.6 to 3.5 and/or a loss tangent of 0.04 to 0.06. It is understood that the permittivity is a relative permittivity taking the permittivity of vacuum as a basis. Due to the properties of the antenna assembly as explained above, the antenna assembly offers a good radiation performance when being located on the carrier layer. Consequently, the roof assembly is highly suitable for connecting an associated vehicle to wireless services.

In an example, the roof assembly further comprises a feeding assembly for the antenna assembly. The feeding assembly and the antenna assembly are offset in a direction perpendicular to a plane defined by the carrier layer. The feeding assembly and the antenna assembly are capacitively coupled. In this context, the carrier layer or any other layer of the roof assembly may be arranged between the antenna assembly and the feeding assembly. Due to the capacitive coupling, it is not necessary to have an electric conductor bridge the offset between the feeding assembly and the antenna assembly. This facilitates the production of the roof assembly.

According to an example, the feeding assembly comprises one single input line and a plurality of power dividers such that each of the tapered slot antennas may be fed with an associated current. Due to the fact that the feeding assembly is offset with respect to the antenna assembly, sufficient space is provided for the elements of the feeding assembly.

In an example, the feeding assembly comprises a first feeding sub-assembly capacitively coupled with a first set of tapered slot antennas of the antenna assembly and a second feeding sub-assembly capacitively coupled with a second set of tapered slot antennas of the antenna assembly. The first feeding sub-assembly and the second feeding sub-assembly are offset in a direction perpendicular to a plane defined by the carrier layer. Thus, the different tapered slot antennas of the antenna assembly are fed using different subassemblies of the feeding assembly. The at least two sub-assemblies of the feeding assembly are offset with respect to one another. This means that the different sub-assemblies are located in different layers. In this context, the carrier layer or any other layer of the roof assembly may be arranged between the first subassembly and the second subassembly. Due to the capacitive coupling, it is not necessary to have an electric conductor bridge the offset between the antenna assembly and the associated subassembly of the feeding assembly. This facilitates the production of the roof assembly. Moreover, providing two sub-assemblies instead of one contiguous feeding assembly enhances the flexibility of integrating the feeding assembly into the roof assembly. This is due to the fact that at least to some extent, the two sub-assemblies may be positioned independent from one another.

According to an example, each of the feeding sub-assemblies comprises one single input line and a plurality of power dividers such that each of the associated tapered slot antennas may be fed with an associated current. Due to the fact that the feeding sub-assemblies are offset with respect to one another and with respect to the antenna assembly, sufficient space is provided for the elements of the feeding sub-assemblies.

In an example, the first feeding sub-assembly and the second feeding sub-assembly are arranged on opposite sides of the antenna assembly. This is a particularly compact arrangement of the feeding sub-assemblies and the antenna assembly within the roof assembly.

In an example, the feeding assembly comprises a feeding line, wherein the feeding line protrudes from the remaining components of the feeding assembly. This especially applies to a case in which the antenna assembly has a substantially circular enveloping contour. In such a case, also the associated portion of the feeding assembly being capacitively coupled to the antenna assembly has a substantially circular enveloping contour. If the feeding line protrudes from the remaining components of the feeding assembly, the feeding line protrudes from this substantially circular enveloping contour. This facilitates the connection of the feeding line to an associated power source or receiver. The same applies if the feeding assembly comprises a plurality of feeding sub-assemblies with associated feeding lines.

According to an example, the roof assembly further comprising a first cover layer arranged on a first side of the carrier layer. Additionally or alternatively the roof assembly comprises a second cover layer arranged on a second side of the carrier layer. The first cover layer and/or the second cover layer may comprise a glass material or may be made from glass material. The mechanical properties of glass material are very suitable for a roof assembly of the vehicle. Additionally, glass material may be transparent or translucent such that the roof assembly may as well be transparent or translucent which is often desired by vehicle users. Moreover, the first cover layer and/or the second cover layer may be used in order to protect the antenna assembly and/or the feeding assembly from environmental influences such as mechanical impacts.

According to an example, the first cover layer and/or the second cover layer has a permittivity of 2 to 8. In an example, the permittivity can be 7.0 to 7.1. Additionally or alternatively, a loss tangent may be 0.0009 to 0.06. According to an example, the loss tangent is 0.01 to 0.03. As has been mentioned before, the permittivity is to be understood as a relative permittivity using the permittivity of vacuum as a basis. As has been mentioned before, the antenna assembly is well suitable for operating in an environment with such permittivities. Consequently, a high performing antenna assembly may be combined with a roof assembly comprising glass layers.

It is noted that even though the roof assembly is described as comprising an antenna assembly according to the present disclosure, the roof assembly may as well comprise any other antenna, e.g. a singular tapered slot antenna. In such an alternative, the antenna assembly according to the present disclosure is replaced by any other antenna such as the singular tapered slot antenna. All other aspects of the roof assembly stay the same, i.e. the above explanations apply mutatis mutandis.

According to an aspect a vehicle is described, wherein the vehicle comprises an antenna assembly; wherein the antenna assembly comprises at least three tapered slot antennas; wherein each of the tapered slot antennas comprises a plate-shaped conductor and a tapered slot extending in the plate-shaped conductor and extending along a slot direction; wherein the slot direction of each of the tapered slot antennas is substantially oriented towards a center point of the antenna assembly; wherein the tapered slot of each of the tapered slot antennas tapers towards the center point; and wherein the slot direction of each of the tapered slot antennas are distributed with respect to circumference extending around the center point.

It should be noted that the above examples may be combined with each other irrespective of the aspect involved.

These and other aspects of the present disclosure will become apparent from and elucidated with reference to the examples described hereinafter.

### BRIEF DESCRIPTION OF DRAWINGS

Examples of the disclosure will be described in the following with reference to the following drawings.

FIG. 1 shows a vehicle comprising a roof assembly according to the present disclosure having an antenna assembly according to the present disclosure, wherein the vehicle is using a wireless service provided by a sender or receiver.

FIG. 2 shows the roof assembly of the vehicle in a separate view along direction II in FIG. 1.

FIG. 3 shows a detail of the roof assembly of FIG. 2.

FIG. 4 shows a detail of the roof assembly of FIG. 2, wherein a perspective opposite to the perspective of FIG. 3 is taken.

FIG. 5 shows a section along direction V-V in FIG. 2.

FIG. 6 illustrates another example of the antenna assembly in a view corresponding to the view of FIG. 4.

FIG. 7 illustrates the example of FIG. 6 in a view corresponding to FIG. 5.

### DETAILED DESCRIPTION

The Figures are merely schematic representations and serve only to illustrate examples of the disclosure. Identical or equivalent elements are in principle provided with the same reference signs.

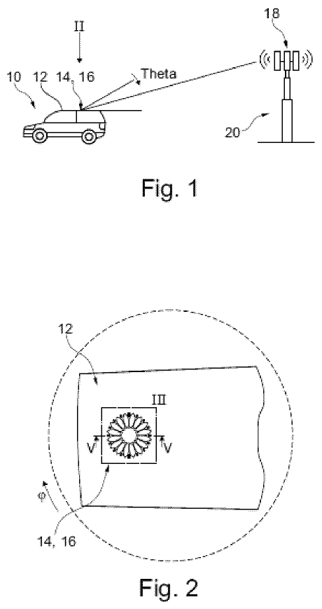

FIG. 1 shows a vehicle 10. The vehicle comprises a roof assembly 12 which in simplified terms may be designated as a glass roof assembly.

The roof assembly 12 comprises an antenna assembly 14 and an associated feeding network 16 which is capacitively coupled to the antenna assembly 14 as will be explained further below.

In the present example, the antenna assembly 14 is a cellular antenna assembly 14 covering all sub-6G bands, i.e. LTE bands including low bands (617-960 MHz) and mid bands (1447.9-2170 MHz) together with 5G bands (e.g. 2300-5 GHZ). The antenna assembly 14 communicates with an antenna 18 in a wireless manner. The antenna 18 can operate in a sending mode or a receiving mode. In the example shown in FIG. 1, the sender antenna 18 is mounted on a cell tower 20.

In this configuration, the main directions of arrival and departure of radio signals exchanged between the antenna assembly 14 and the sender antenna 18 are generally uniformly spread in azimuth φ, but cluster around an elevational angle theta in the range of 60 to 90 degrees (cf. FIGS. 1 and 2 in combination).

Therefore, the radiation pattern of the antenna assembly is omni-directional over the azimuth plane and across the theta angles of 60 to 90 degrees without any deep nulls throughout the frequency band.

In the following, the roof assembly 12 and the antenna assembly 14 will be described in more detail with reference to FIGS. 2 to 5. In this context, the antenna assembly 14 may as well be designated as a radiator.

In the example shown in the Figs, the antenna assembly 14 comprises a total of 16 tapered slot antennas 22.

These tapered slot antennas 22 use a common conductor 24 which is plate-shaped.

This conductor 24 and, thus, the antenna assembly 14 comprises a center point 26.

Each of the tapered slot antennas 22 comprises a tapered slot 28 extending along a slot direction 30. The borders of each tapered slot 28 follow an exponential function.

All slot directions 30 of all tapered slot antennas 22 are oriented towards the center point 26.

Moreover, all inner ends of all tapered slots 28 are located on a common circular circumference extending around the center point 26.

In the same manner, all outer ends of all tapered slots 28 are located on a common circular circumference extending around the center point 26.

Furthermore, all tapered slots 28 taper towards the center point 26.

Additionally, the slot directions 30 and, thus, all tapered slots 28 are evenly distributed with respect to a circumference extending around the center point 26.

This configuration results in a flower-shape or star-shape of the conductor 24.

Moreover, at the narrow end of each of the tapered slots 28, an elliptical resonant cavity 32 is provided. The elliptical resonant cavity 32 is formed as a through hole with an elliptical cross-section.

Furthermore, the tapered slots 28 are arranged in the common conductor 24 such that respective widest slot widths W of neighboring tapered slot antennas 22 are directly adjacent to one another. This means that the tapered slots 28 are arranged such that it is geometrically not possible to move the slots 28 further towards the center point 26 without amending the geometry of the slots 28.

In the example of the Figs, the widest slot width corresponds to 0.09 times the largest wavelength of the bandwidth. Expressed in millimeters (mm), the widest slot width W amounts to 44 mm.

As far as the length L of the tapered slots 28 is concerned, this length L corresponds to 0.14 times the largest wavelength of the bandwidth. Expresses in millimeters, the length L amounts to 62 mm.

This results in a largest radius R of the common conductor 24 to correspond to 0.26 times the largest wavelength of the bandwidth.

Expressed in millimeters, the largest radius R amounts to 113.5 mm.

Furthermore, due to the above-described configuration of the common conductor 24, all inner ends of all tapered slots 28 are arranged on a circular line around the center point 26. The circular line has a diameter D of 0.25 times the largest wavelength of the bandwidth. Expressed in millimeters, the diameter D amounts to 107 mm.

Due to the fact that all tapered slot antennas 22 use a common conductor 24, the plate-shaped conductors 34 associated with each of the tapered slot antennas 22 are conductively coupled. In this context, each plate-shaped conductor 34 associated with a single one of the tapered slot antennas 22 may be regarded as a circular sector having the associated tapered slot 28 in its middle.

The antenna assembly 14 additionally comprises a total of 16 groups of strip-shaped conductor elements 36. In the present example, each group comprises 5 strip-shaped conductor elements 36.

In each group of strip-shaped conductor elements 36, each strip-shaped conductor element 36 has a length LS of 8 mm and a width WS of 0.5 mm.

Within one group, all 5 strip-shaped conductor elements 36 are arranged in parallel, wherein a distance DS between neighboring strip-shaped conductor elements 36 amounts to 2.5 mm.

All groups of strip-shaped conductor elements 36 are designed in the same manner.

As far as the arrangement of the groups of strip-shaped conductor elements 36 in the associated tapered slots 28 is concerned, all strip-shaped conductor elements 36 are oriented in parallel to a tangent which may be created in a point where the associated slot direction 30 intersects a circle enveloping the common conductor 24.

Moreover, all strip-shaped conductor elements 36 are arranged inside this enveloping circle.

The strip-shaped conductor elements 36 are centered on the slot direction 30.

Thus, the strip-shaped conductor elements 36 are arranged at a distance from the associated edges of the associated tapered slot 28.

This means that none of the strip-shaped conductor elements 36 is connected to the common conductor 24 in an electrically conductive manner.

The strip-shaped conductor elements 36 are made from the same material as the common conductor 24.

In the examples shown in the Figs., the strip-shaped conductor elements 36 and the common conductor 24 are made of a copper mesh material.

It is noted that for reasons of better visibility, only some of the tapered slot antennas 22, only some of the tapered slots 28, only some of the slot directions 30, only some of the elliptical resonant cavities 32 and only some of the plate-shaped conductors 34 are provided with a reference sign.

The feeding assembly 16 is used in order to provide a current to the antenna assembly 14. As has been mentioned before, the feeding assembly 16 is capacitively coupled to the antenna assembly 14.

To this end, the feeding assembly 16 comprises a total of 16 fan-shaped stubs 38. Each fan-shaped stub 38 is delimited by two straight edges meeting at their first respective ends and enclosing an angle of approximately 80°. The respective second ends of the straight edges are connected by a circular edge segment.

Each of the fan-shaped stubs 38 is associated with one of the tapered slot antennas 22 and is configured to generate a current in the associated tapered slot antenna 22. To this end, each of the fan-shaped stubs 38 is offset from the antenna assembly 14, i.e. from the common conductor 24 along a direction perpendicular to a plane as defined by the common conductor 24. However, each of the fan-shaped stubs 38 is located opposite the associated slot antenna 22, more precisely, the corner of each fan-shaped stub 38 where the two straight edges meet is placed over a narrow end of the tapered slot 28 of the associated tapered slot antenna 22.

Furthermore, the feeding assembly 16 comprises a total of 16 L-shaped conductor segments 40 each of the L-shaped conductor segments 40 is connected to an associated fan-shaped stub 38 in an electrically conductive manner. The L-shaped conductor segments 40 are arranged in the same plane as the fan-shaped stubs 38. Moreover, the L-shaped conductor segments 40 are arranged such that they go around the associated elliptical resonant cavity 32.

All fan-shaped stubs 38 are fed using a common port 42 of the feeding assembly 16.

In order to do so, a network 44 of power dividers 46 is provided between the common port 42 and each of the fan-shaped stubs 38.

In this context, each of the power dividers is Y-shaped in the sense that it comprises a first terminal which may be an input terminal and which is located at the basis of the Y-shape and two second terminals which are located at respective upper ends of the Y-shape. The second terminals may be output terminals. Consequently, using a total of 15 power dividers 46, the common port 42 and each of the fan-shaped stubs 38 are connected in an electrically conductive manner. This means that an input power associated with the common port 42 may be split and supplied to a total of sixteen fan-shaped stubs 38, i.e. the power is divided 1:16. This applies mutatis mutandis if the antenna assembly 14 operates in a receiving mode.

For reasons of better visibility, only some of the fan-shaped stubs 38, only some of the L-shaped conductor segments 40, and only some of the power dividers 46 are provided with a reference sign.

The feeding assembly 16 is made from a copper mesh material.

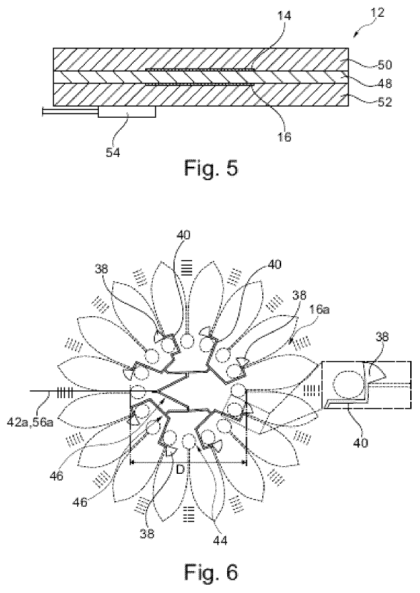

The arrangement of the antenna assembly 14 and the feeding assembly 16 within the roof assembly 12 may best be seen in FIG. 5.

The roof assembly 12 comprises a total of three layers: A carrier layer 48, a first cover layer 50 and a second cover layer 52.

In the present example, the carrier layer is made from polyvinyl butyral (PVB).

Both the first cover layer 50 and the second cover layer 52 are made from glass.

In the present example, the carrier layer 48 has a permittivity of 2.6 to 3.5 and a loss tangent of 0.04 to 0.06. It is understood that the permittivity is a relative permittivity taking the permittivity of vacuum as a basis.

The first cover layer 50 and the second cover layer 52 have a permittivity of 7.0 to 7.1 and a loss tangent of 0.01 to 0.03.

In the present example, the antenna assembly 14 and the feeding assembly 16 are arranged on opposite sides of the carrier layer 48.

Thus, the feeding assembly 16 and the antenna assembly 14 are offset in a direction perpendicular to a plane defined by the carrier layer 48. A dimension of the offset corresponds to a thickness of the carrier layer 48.

As has been mentioned before, the antenna assembly 14 and the feeding assembly 16 are capacitively coupled. This means that it is not necessary to have a conductor penetrating the carrier layer 48.

More precisely, the side of the carrier layer 48 on which the antenna assembly 14 is arranged, corresponds to a top side of the roof assembly 12 if the roof assembly 12 is used in a vehicle.

The first cover layer 50 covers the carrier layer 48 and the antenna assembly 14 on the top side.

Consequently, the side of the carrier layer 48 on which the feeding assembly 16 is arranged, corresponds to a lower side of the roof assembly 12 if the roof assembly 12 is used in a vehicle.

The second cover layer 52 covers the carrier layer 48 and the feeding assembly 16 on the lower side.

FIG. 5 additionally shows an electromagnetic connector 54 which is capacitively coupled to the feeding assembly 16, more precisely to the common port 42 of the feeding assembly 16.

The electromagnetic connector 54 is used to power the antenna assembly 14 via the feeding assembly 16.

It is noted that the electromagnetic connector 54 may be considered to form part of the roof assembly 12. Alternatively, the electromagnetic connector 54 may be considered to form part of the vehicle, i.e. not of the roof assembly 12 as such.

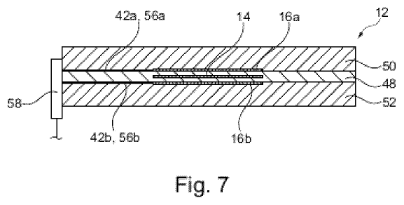

FIGS. 6 and 7 illustrate another example of the roof assembly 12. In the following, only the differences with respect to the previous example will be explained.

In the example of FIGS. 6 and 7, the antenna assembly 14 is the same as in the example of FIGS. 1 to 5. However, as far as the integration into the layers of the roof assembly 12 is concerned, the antenna assembly 14 now is embedded in the carrier layer 48. This means that the antenna assembly 14 is arranged in an interior of the carrier layer 48, wherein the antenna assembly 14 is located at a distance both from an upper side and a lower side of the carrier layer 48.

A further difference concerns the feeding assembly 16. In the example of FIGS. 6 and 7, the feeding assembly 16 comprises a first feeding sub-assembly 16a and a second feeding sub-assembly 16b.

Each of the feeding sub-assemblies 16a, 16b is configured to feed a total of 8 tapered slot antennas 22. To this end, each of the feeding sub-assemblies 16a, 16b is capacitively coupled to the associated tapered slot antennas 22.

In this context, the design of the feeding sub-assemblies 16a, 16b generally corresponds to the design of the feeding assembly 16 as shown in FIG. 4. However, the feeding sub-assemblies 16a, 16b have been adapted to the reduced amount of associated tapered slot antennas 22.

FIG. 6 shows the feeding sub-assembly 16a. However, the feeding sub-assembly 16b is identical.

When integrated into the roof assembly 12, the feeding sub-assembly 16a is capacitively coupled with a first set of tapered slot antennas 22 of the antenna assembly 14. To this end, the feeding sub-assembly 16a is located on a first side of the carrier layer 48 which in the present example is a top side.

The feeding sub-assembly 16b is capacitively coupled with the second set of tapered slot antennas 22 of the antenna assembly 14. To this end, the feeding sub-assembly 16b is located on a second side of the carrier layer 48 which in the present example is a lower side.

Thus, the first feeding sub-assembly 16a and the second feeding sub-assembly 16b are arranged on opposite sides of the antenna assembly 14.

Put otherwise, the first feeding sub-assembly 16a and the second feeding sub-assembly 16b are both offset from the antenna assembly 14 in a direction perpendicular to a plane defined by the carrier layer 48. Moreover, the first feeding sub-assembly 16a and the second feeding sub-assembly 16b are offset in the same direction with respect to each other.

In the example of FIGS. 6 and 7, the first cover layer 50 covers the first feeding sub-assembly 16a and the carrier layer 48 on a top side.

The second cover layer 52 covers the second feeding sub-assembly 16b and the carrier layer on a lower side.

Another difference of the example of FIGS. 6 and 7 relates to the powering of the feeding sub-assemblies 16a, 16b. In this example, each of the feeding sub-assemblies 16a, 16b comprises a common port 42a, 42b electrically connected to the associated fan-shaped stubs 38.

In the example of FIGS. 6 and 7, this common port 42a, 42b is formed by a respective feeding lines 56a, 56b protruding towards an edge of the roof assembly 12. At the edge of the roof assembly 12, the feeding lines 56a, 56b may be connected to an electric connector 58 in an electrically conductive manner.

It is noted that according to a variant of the example of FIGS. 6 and 7, the sub-assembly 16a, 16b may as well be powered using an electromagnetic connector as has been explained in connection with the first example.

It is further noted that even though a roof assembly 12 with one single antenna assembly 14 and one single associated feeding assembly 16 has been explained, it is possible to equip a roof assembly 12 with two or more antenna assemblies 14 and, consequently, two or more associated feeding assemblies 16. Each of the plurality of antenna assemblies 14 may be used for a different wireless service which may be provided to the vehicle 10.

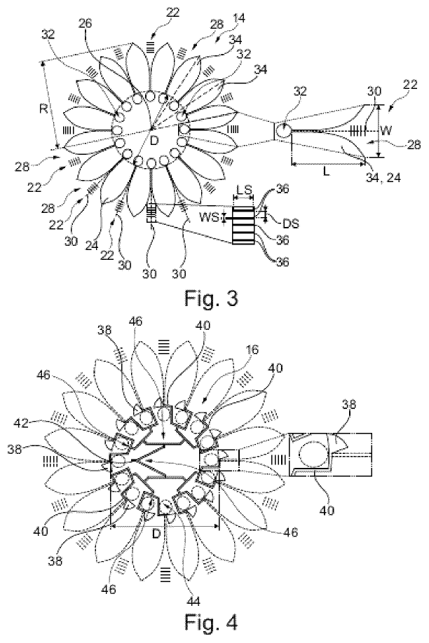

It is additionally noted that even though the roof assembly 12 was explained in connection with an antenna assembly 12 as shown in FIGS. 2 and 3 and a feeding assembly as shown in FIGS. 4 and 6, the roof assembly may as well comprise any other antenna assembly instead of the antenna assembly 14. It is understood that in such a case also another feeding assembly is used.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one example, to at least one, optionally including more than one, A, with no B present (and optionally including entities other than B); in another example, to at least one, optionally including more than one, B, with no A present (and optionally including entities other than A); in yet another example, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

Other variations to the disclosed examples can be understood and effected by those skilled in the art in practicing the claimed disclosure, from the study of the drawings, the disclosure, and the appended claims. In the claims the word “comprising” does not exclude other elements or steps and the indefinite article “a” or “an” does not exclude a plurality. A single processor or other unit may fulfill the functions of several items or steps recited in the claims. The mere fact that certain measures are recited in mutually different dependent claims does not indicate that a combination of these measures cannot be used to advantage. A computer program may be stored/distributed on a suitable medium such as an optical storage medium or a solid-state medium supplied together with or as part of other hardware, but may also be distributed in other forms, such as via the Internet or other wired or wireless telecommunication systems. Any reference signs in the claims should not be construed as limiting the scope of the claims.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances. As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances.

As used herein the term “component” refers to a distinct and identifiable part, element, subsystem, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software, and/or other engineering elements.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software product.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

### LIST OF REFERENCE SIGNS

10 vehicle
12 roof assembly
14 antenna assembly
16 feeding assembly
18 sender antenna
20 cell tower
22 tapered slot antenna
24 common conductor
26 center point
28 tapered slot
30 slot direction
32 elliptical resonant cavity
34 plate-shaped conductor
36 strip-shaped conductor element
38 fan-shaped stub
40 L-shaped conductor segment
42 common port of the feeding assembly
44 network of power dividers
46 power divider
48 carrier layer
50 first cover layer
52 second cover layer
54 electromagnetic connector
56a feeding line
56b feeding line
58 electric connector
D diameter
W widest slot width
L length of the tapered slot
R largest radius of the common conductor
LS length of strip-shaped conductor element
WS width of strip-shaped conductor element
DS distance between neighboring strip-shaped conductor elements

What is claimed is:

1. An antenna assembly comprising:
at least three tapered slot antennas;
wherein each of the tapered slot antennas comprises a plate-shaped conductor and a tapered slot extending in the plate-shaped conductor and extending along a slot direction;
wherein the slot direction of each of the tapered slot antennas is substantially oriented towards a center point of the antenna assembly;
wherein the tapered slot of each of the tapered slot antennas tapers towards the center point; and
wherein the slot direction of each of the tapered slot antennas are distributed with respect to a circumference extending around the center point.

2. The antenna assembly of claim 1, wherein each of the tapered slot has a widest slot width; and wherein widest slot widths of neighboring tapered slot antennas are directly adjacent to one another.

3. The antenna assembly of claim 1, wherein each of the tapered slot has a widest slot width, and wherein the widest slot width corresponds to 0.05 times to 0.15 times the largest wavelength of a bandwidth of the antenna assembly.

4. The antenna assembly of claim 1, wherein each of the tapered slot has a slot length, and wherein the slot length corresponds to 0.1 times to 0.2 times the largest wavelength of a bandwidth of the antenna assembly.

5. The antenna assembly of claim 1, wherein the plate-shaped conductor of each of the at least three tapered slot antennas are one of galvanically and electromagnetically coupled.

6. The antenna assembly of claim 5, wherein the plate-shaped conductors of the at least three tapered slot antennas are formed by a common conductor.

7. The antenna assembly of claim 6, wherein a largest radius of the common conductor corresponds to 0.15 times to 0.35 times the largest wavelength of a bandwidth of the antenna assembly.

8. The antenna assembly of claim 1, wherein at least one strip-shaped conductor element is arranged at least partially in at least one of the tapered slot of each of the tapered slot antennas.

9. The antenna assembly) of claim 8, wherein a group comprising a plurality of strip-shaped conductor elements is arranged at least partially in at least one of the tapered slot of each of the tapered slot antennas adjacent to a wide end of an associated slot.

10. The antenna assembly of claim 1, comprises four to one hundred slot antennas.

11. The antenna assembly of claim 1, wherein the tapered slot is delimited by convex curved edges of the respective plate-shaped conductor.

12. The antenna assembly of claim 4, wherein the slot length is measured as a distance between two opposite ends of the tapered slot.

13. The antenna assembly of claim 8, wherein the strip-shaped conductor comprises one of a partially transparent material, a translucent material, and a mesh material.

14. A roof assembly for a vehicle, comprising:
a carrier layer and at least one antenna assembly;
wherein the antenna assembly comprises of at least three tapered slot antennas;
wherein each of the tapered slot antennas comprises a plate-shaped conductor and a tapered slot extending in the plate-shaped conductor and extending along a slot direction;
wherein the slot direction of each of the tapered slot antennas is substantially oriented towards a center point of the antenna assembly;
wherein the tapered slot of each of the tapered slot antennas tapers towards the center point; and
wherein the slot direction of each of the tapered slot antennas are distributed with respect to a circumference extending around the center point; and
wherein at least one antenna assembly is arranged on the carrier layer.

15. The roof assembly of claim 14, further comprising a feeding assembly for the antenna assembly, wherein the feeding assembly and the antenna assembly are offset in a direction perpendicular to a plane defined by the carrier layer and, wherein the feeding assembly and the antenna assembly are capacitively coupled.

16. The roof assembly of claim 15, wherein the feeding assembly comprises a first feeding sub-assembly capacitively coupled with a first set of tapered slot antennas of the antenna assembly and a second feeding sub-assembly capacitively coupled with a second set of tapered slot antennas of the antenna assembly, and wherein the first feeding sub-assembly and the second feeding sub-assembly are offset in a direction perpendicular to a plane defined by the carrier layer.

17. The roof assembly of claim 16, wherein the first feeding sub-assembly and the second feeding sub-assembly are arranged on opposite sides of the antenna assembly.

18. The roof assembly of claim 15 wherein the feeding assembly comprises a feeding line, and wherein the feeding line protrudes from the remaining components of the feeding assembly.

19. The roof assembly of claim 14, further comprising one of a first cover layer arranged on a first side of the carrier layer and a second cover layer arranged on a second side of the carrier layer, wherein one of the first cover layer and the second cover layer comprises a glass material.

20. A vehicle comprising an antenna assembly, wherein the antenna assembly comprises:
at least three tapered slot antennas;
wherein each of the tapered slot antennas comprises a plate-shaped conductor and a tapered slot extending in the plate-shaped conductor and extending along a slot direction;
wherein the slot direction of each of the tapered slot antennas is substantially oriented towards a center point of the antenna assembly;
wherein the tapered slot of each of the tapered slot antennas tapers towards the center point; and
wherein the slot direction of each of the tapered slot antennas are distributed with respect to a circumference extending around the center point.
